(19) United States
(12) Patent Application Publication
(10) Pub. No.: US 2015/0335410 A1
(43) Pub. Date: Nov. 26, 2015

(54) FULL ARCH ULTRASONIC CLEANER APPARATUS AND METHOD OF USE

(71) Applicant: Kun Zhao, Quincy, MA (US)

(72) Inventor: Kun Zhao, Quincy, MA (US)

(21) Appl. No.: 14/716,814

(22) Filed: May 19, 2015

Related U.S. Application Data
(60) Provisional application No. 62/000,568, filed on May 20, 2014.

(51) Int. Cl. A61C 17/20; A61C 17/00

(52) U.S. Cl. CPC A61C 17/20; A61C 17/005

(57) ABSTRACT

A cleaner apparatus for use in a dental prophylaxis process includes an applicator defining a curved occlusal wall, a buccal wall, a lingual wall, and a distal wall, each of the buccal wall, the lingual wall and distal walls extending outwardly from the occlusal wall and forming a curved applicator configured to receive a patient's teeth in one of the maxillary arch and mandibular arch of the patient. The applicator being configured to receive and contain a cleaning agent in the cavity during a teeth cleaning process. An ultrasonic transducer is embedded within each of the buccal wall and the lingual wall of the applicator. A controller is electrically coupled to the transducers for powering the transducers and controlling the operation thereof, and the cleaner apparatus for cleaning a full arch of a patients teeth via cavitation of the cleaning agent resulting from ultrasonic radiation transmitted from the transducers.

This application claims the benefit under 35 U.S.C. §119(e) of U.S. Provisional Application No. 62/000,568 filed May 20, 2014, the entire disclosure of which is hereby incorporated by reference.

### FIELD OF THE INVENTION

The present disclosure relates generally to a full arch ultrasonic cleaner apparatus for use in the field of dental prophylaxis and method of use thereof. More particularly, the disclosure relates to a full arch ultrasonic cleaner apparatus including an applicator defining a cavity for receiving a cleaning agent and a plurality of ultrasonic transducers mounted to the applicator. Also disclosed is a method of using the cleaner apparatus in dental prophylactic treatments.

### BACKGROUND OF THE INVENTION

The statements in this section merely provide background information related to the present disclosure and may not constitute prior art.

Gingivitis and periodontitis are the most common diseases of mankind. This is a group of diseases commonly referred as periodontal disease. Periodontal disease is caused by bacteria in dental plaque and calculus. Thus, removal of plaque and calculus is not only a preventive measure, but also the essential part of the treatment in periodontal disease. Carefully performed home care through brushing and flossing of one's teeth can well control the formation of plaque and calculus, and also remove soft plaque. However, plaque and calculus build-up in areas difficult to access typically requires a well trained, highly skilled dental professional to remove. Mechanical removal of plaque and calculus by dental professionals is therefore the corner stone of modern preventive dentistry.

In a current dental prophylaxis treatment, a dental professional typically removes plaque and calculus from a patient's teeth using hand instruments such as a scaler, sickle and curette. An ultrasonic scaler may also be used. While the dental professional can remove the plaque and calculus from a patient's teeth using these types of instruments, the process also includes significant drawbacks including those described following:
1. Patients often experience discomfort due to gingival trauma associated with contact from sharp tools which is not entirely avoidable even during a cleaning process involving a highly skilled dentist or dental hygienist;
2. Use of an ultrasonic scaler can exacerbate the problem of gingival trauma;
3. Patients may incur increased sensitivity induced by sharp metal tip scaling across tooth surfaces, especially around the cervical area (around the gum line). An ultrasonic scaler can make a sensitivity problem worse.
4. Patient's required to hold their mouth open for long periods of time during a teeth cleaning process often experience discomfort due in part to joint fatigue and stress;
5. The above-described currently used dental prophylaxis process is time consuming as typically, each surface of each tooth is cleaned one surface at a time by a dental professional;
6. Dental practitioners often experience hand fatigue and stress due to long periods of hand instrumentation; and
7. Dental practitioners often experience shoulder and back pain due to extensive time spent holding certain postures during dental prophylaxis processes.

It is an object of the present teachings to provide a full arch ultrasonic cleaner apparatus that overcomes the shortcomings of prior art tools and methods.

### SUMMARY OF THE INVENTION

This section includes a general summary of the disclosure and does not provide a comprehensive description or include full scope or all the features of the subject matter disclosed.

According to one aspect, the present teachings provide an ultrasonic cleaner apparatus for use in a dental prophylaxis process including an applicator defining a curved occlusal wall, a buccal wall, a lingual wall, and a distal wall, each of the buccal wall, the lingual wall and a distal walls extending outwardly from the occlusal wall and cooperating to form an arch-shaped cavity configured to receive a patient's teeth in one of the maxillary arch and mandibular arch of the patient, the applicator being further configured to receive and contain a cleaning agent in the cavity during a teeth cleaning process. The cleaner apparatus further includes an ultrasonic transducer embedded within each of the buccal wall and the lingual wall of the applicator. A controller is electrically connectable to the transducers for powering the transducers and controlling the operation thereof, wherein the cleaner apparatus is configured for cleaning a full arch of a patients teeth via cavitation of the cleaning agent resulting from ultrasonic radiation transmitted from the transducers.

In another aspect, the cleaner apparatus includes a set of applicators including a first applicator configured for use with the maxillary arch of the patient, and a second applicator configured for use with the mandibular arch of the patient wherein the first and second applicators are different one from the other.

In yet another aspect, the cleaner apparatus includes the controller being configured to operate the transducers in accordance with a predetermined time duration.

In another aspect, the cleaner apparatus defines a cavity having a uniform width throughout a length of the cavity.

In another aspect, the cleaner apparatus includes an applicator which defines an arch-shaped cavity having a width that varies from a narrowest point near an anterior end of the cavity to wider points at each of a pair of opposing distal ends of the applicator.

Also disclosed is a method of cleaning a patient's teeth using a full arch ultrasonic cleaning apparatus, the method including the steps, providing a cleaning apparatus including an applicator defining a curved occlusal wall, a buccal wall, a lingual wall, and a distal wall, each of the buccal wall, the lingual wall and a distal walls extending outwardly from the occlusal wall and forming a curved applicator configured to receive a patient's teeth in one of the maxillary arch and mandibular arch of the patient, the applicator being further configured to receive and contain a cleaning agent in the cavity during a teeth cleaning process; at least one ultrasonic transducer embedded within each of the buccal wall and the lingual wall of the applicator, and a controller electrically coupled to the transducers for powering the transducers and controlling the operation thereof; loading a cleaning agent in the cavity; applying the applicator to one of the maxillary arch and the mandibular arch of the patient; operating the controller to apply electrical power to at least one of the ultrasonic transducers thereby causing cavitation in the cleaning agent; and wherein the cavitation in the cleaning agent works to remove plaque and calculus from the patient's teeth.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description, the appended claims and the following drawings. The drawings are for illustrative purposes only and are not intended to limit the scope of the present disclosure.

FIG. 1 is an illustration of one embodiment of a ultrasonic cleaner apparatus in accordance with the present invention.

FIG. 2 is a perspective view of one embodiment of an applicator according to the present invention cleaner apparatus.

FIG. 3A is a partial cutaway perspective view of an embodiment of an applicator according to the present invention.

FIG. 3B is partial cutaway perspective view of another embodiment of an applicator according to the present invention.

FIG. 4 is a cross sectional view of another embodiment of an applicator according to the present invention configured for use with the maxillary arch of a patient.

FIG. 5 is a cross-sectional view of an embodiment of an applicator according to the present invention configured for use with the mandibular arch of a patient.

FIG. 6 is a top view of an embodiment of an applicator according to the present invention.

FIG. 7 is a top view of another embodiment of an applicator 12 of the present invention.

### DETAILED DESCRIPTION OF EMBODIMENTS OF THE INVENTION

Detailed illustrative descriptions of example embodiments are disclosed herein. However, specific structural and functional details disclosed herein are merely representative for purposes of describing example embodiments. The example embodiments may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the language explicitly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

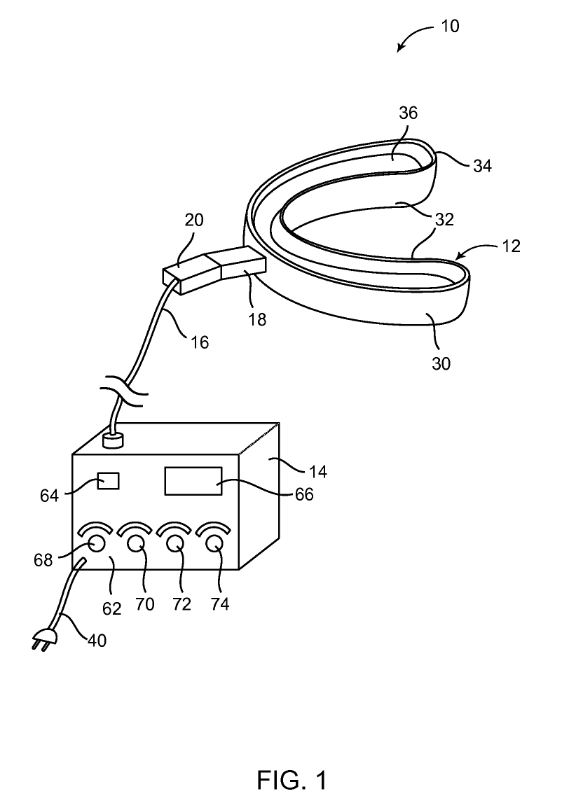

FIGS. 1-4 illustrate an example embodiment full arch cleaner apparatus 10 according to the present invention. The cleaner apparatus 10 includes an intra-oral applicator 12 and a controller 14 electrically coupled to the applicator. The controller 14 includes an electrical wire or cable 16 connecting the controller to the applicator 12. In the FIG. 1 embodiment, an electrical connector 20 removably attaches the cable 16 to the applicator 12 through a handle 18 of the applicator.

The applicator 12 defines an open cavity 22 formed between a buccal wall 30, a lingual wall 32, a distal wall 34 and an occlusal wall 36. Each of the buccal wall 30, the lingual wall 32 and distal wall 34 extend outwardly and generally perpendicular from the occlusal wall 36. The cavity 22 is configured to receive and contain a cleaning agent (not shown) and to receive the upper or lower teeth of the patient. Depending on the placement of the applicator 12 within a patient's mouth, the applicator 12 is configured to clean an entire dental arch of the patient at one time.

The applicator 12 is configured to fit into the oral cavity of a patient and enclose the teeth of one of the maxillary arch (upper teeth) and mandibular arch (lower teeth) of a dental patient. The cavity 22 of applicator 12 is configured to receive the upper or lower teeth, depending on the placement of the applicator 12 within the patient's mouth, and to allow space adjacent the teeth and within the cavity for the cleaning agent to engage the surfaces of the teeth during a cleaning process.

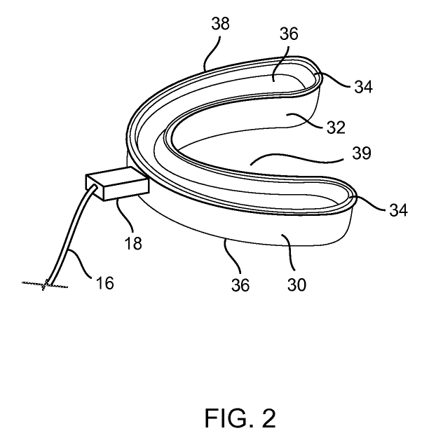

Referring to FIG. 2, the applicator 12 is formed of a substantially rigid waterproof material such as plastic, rubber, metal or other type of durable material capable of maintaining the shape of the arch and withstanding harsh conditions such as heat sterilization. Each of the buccal wall 30, lingual wall 32, and occlusal wall 36 of the applicator 12 are curved to conform to one of the maxillary and/or mandibular arches of a patient and are configured to define a tongue opening 39 which allows room for a patient's tongue when the applicator 12 is installed in the mouth of the patient. The tongue opening 39 allows for normal and comfortable movement of the tongue when the applicator 12 is in place within the oral cavity of a patient.

In various embodiments, the applicator 12 is sized appropriately for children and adults, with small, medium, and large dental arch forms. In one embodiment, the applicator 12 includes a plurality of the applicators 12 forming a set of applicators for use in a dental practice. The plurality of applicators 12 may be color-coded according to a size, e.g. red applicator=small size; blue applicator=medium size; green applicator=large size. As discussed below, the applicator 12 also includes various embodiments configured for use with one or the other of the maxillary arch (upper arch) or the mandibular arch (lower arch) of a patient. For example, in one embodiment, the cleaner apparatus 10 may include a plurality of applicators 12 color-coded for each of extra small, small, medium, large, and extra-large dental arches for each of the upper arch and the lower arch. The color-coded applicators 12 may include light and dark colors for differentiating between the applicators 12 for the upper and lower arches respectively, or the applicators 12 can be marked with a “U” on the applicators for the upper arch and an “L” on the applicators for use with a patient's lower arch. The markings “U” and “L” are provided for easily distinguishing between the different applicators 12 for use with the upper and lower arches, respectively. In another example embodiment, a light green applicator 12 may be configured as a large size applicator for use with the maxillary arch, whereas a dark green applicator 12 may be a large size applicator configured for use with a patient's mandibular arch.

Referring to the embodiment of FIG. 2, a gingival seal 38 is formed with, or attached to the applicator 12 and extends along the entire edge of each of the buccal wall 30, the lingual wall 32, and the distal wall 34 at the opening of cavity 22. In the FIG. 2 embodiment, a width of the gingival seal 38 is greater than a thickness of the walls 30, 32, 34 of the applicator 12 for sealing against the gums of the patient when the applicator 12 is positioned in place within the mouth of the patient. In one embodiment the gingival seal 38 is formed integrally with, and of the same material as the walls 30, 32, 34 of the applicator 12. In other embodiments the gingival seal 38 is formed separately from the applicator 12 and attached thereto via an adhesive, chemical bond or weld or other type of bond or bonding method. Accordingly, in various embodiments of the applicator 12, the gingival seal 38 can be formed of the same material as the applicator or from a different type of soft, resilient material. The gingival seal 38 is configured to engage the gums of a patient and seal thereagainst for containing a cleaning agent within the cavity 22 of the applicator 12 during a teeth cleaning process.

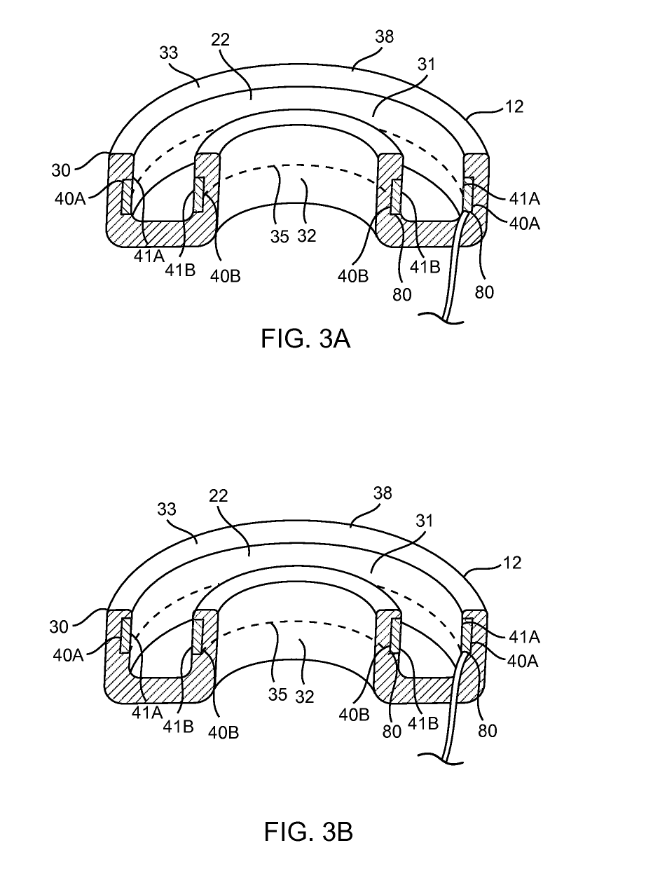

FIG. 3A shows a partial sectional view of one embodiment of applicator 12 including a plurality of ultrasonic transducers 40A, 40B embedded within the buccal wall 30 and the lingual wall 32, respectively. The ultrasonic transducers 40A, 40B are disposed in applicator 12 so as to direct ultrasonic radiation (ultrasound) from the outputs 41A, 41B of the transducers 40A, 40B, respectively, toward the buccal and lingual surfaces of the patient's teeth when turned on and electrical power is applied to the transducers via the controller 14. The ultrasound causes cavitation in a cleaning agent disposed in the cavity 22 of the applicator. As is known by those skilled in the art with respect to ultrasound cleaner apparatus (e.g. ultrasonic cleaners used for cleaning dental tools) cavitation causes bubbles induced by high frequency pressure (sound) waves to agitate the cleaning agent. In the cleaner apparatus 10, the agitation produces high forces on contaminants such as plaque and calculus adhering to the patient's teeth. The cavitation also causes the cleaning agent to penetrate spaces and recesses between a patient's teeth. Thus, the cleaning processes performed by the apparatus 10 of the present invention is designed to thoroughly remove all traces of plaque and calculus adhering or embedded onto all of the exposed surfaces of a patient's teeth which is in contact with the liquid cleaning agent.

Referring now to FIGS. 3A, 3B, 6, and 7, the ultrasonic transducers 40A are spaced apart one from the other and disposed within the buccal wall 30 so that an output 41A of the transducer is directed toward the cavity 22 and facing the buccal surfaces of the patient's teeth. In various embodiments of applicator 12, the outputs 41A of the transducers 40A are spaced apart and/or positioned along the buccal wall 30 for concentration of the cavitation produced by the transducers opposite certain locations of the dentition conducive to collecting plaque and/or calculus. In one embodiment, the applicator 12 includes approximately ten transducers 40A arranged along the length of the buccal wall 30. In other embodiments, the applicator 12 may include more or less than ten transducers 40A positioned along the buccal wall 30 of the applicator 12.

Similarly, the applicator 12 includes a plurality of transducers 40B disposed within the lingual wall 32 so that an output 41B is directed toward the cavity 22 and facing the lingual surfaces of the patient's teeth. The spacing of the transducers 41B can be varied throughout the length of the lingual wall 32. For example, in an applicator 12 designed for use with the mandibular arch, the spacing of the transducers 40B may be configured to include close spacing or more transducers 40B near an anterior portion of the lingual wall 32 which is a location known for the occurrence of supragingival calculus in many patients.

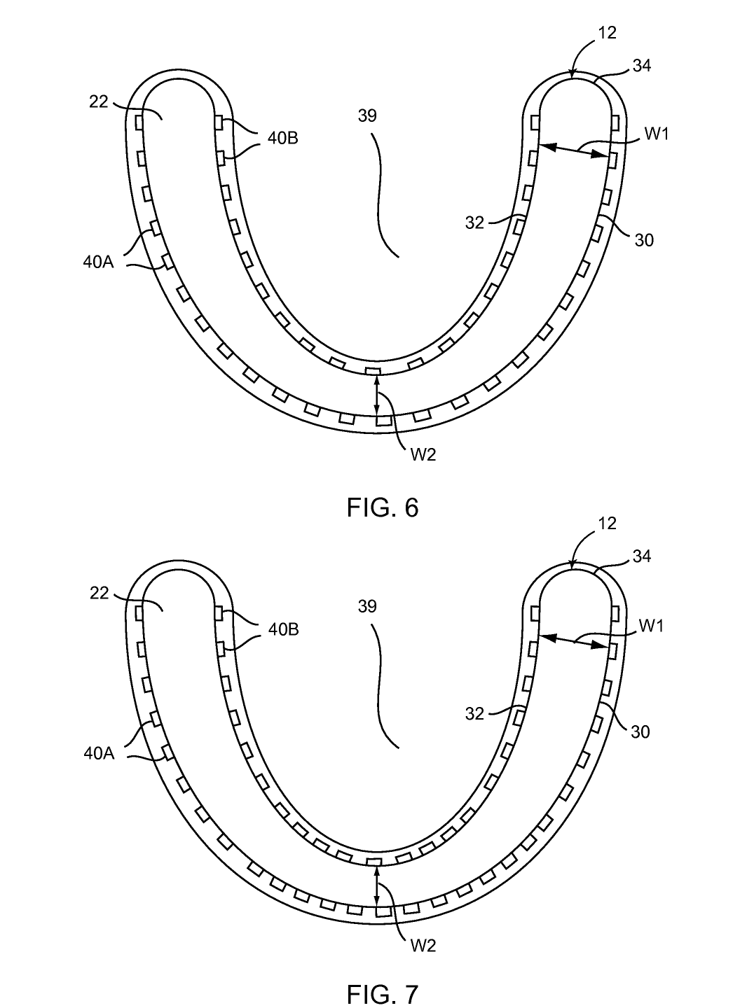

As shown in the FIG. 6 embodiment, the transducers 40A and 40B are embedded in the buccal wall 30 and lingual wall 32, respectively of the applicator 12 and equally spaced apart along a length of the applicator. In the FIG. 7 embodiment, the transducers 40A, 40B are spaced closer together near the anterior end of the applicator 12. The closely spaced transducers in the FIG. 7 embodiment provides increased cavitation in the cavity 22 proximal a patient's anterior teeth for increased cleaning action near the teeth having greater susceptibility to the occurrence of plaque and calculus. In both the FIG. 6 and FIG. 7 embodiments, the outputs 41A, 41B of the transducers 40A, 40B respectively are directed towards the cavity 22 of the applicator 12. In other embodiments, the applicator 12 can include other variations of the spacing of the transducers 40A, 40B relative to one another.

Referring to FIG. 3B, the transducers 40B can be positioned with a center of an output 41B of the transducer 40B located between a center line 35 of the lingual wall 32 and the opening of the cavity 22 for locating the transducers closer to an apical portion of the patient's teeth. Positioning the transducer 41B closer to the opening of the applicator 12 increases cavitation of the cleaning agent proximal common areas of calculus and plaque. Similarly, the buccal wall 30 defines a center line 31 along a length thereof and midway between the occlusal wall 36 and an upper end 33 of the buccal wall. In various embodiments, the applicator 12 can include the transducers 40A positioned between the center line 31 and the opening of the cavity 22 (closer to the upper end 33 of the buccal wall than the occlusal wall 36) for locating the output 41A of the transducer 40A closer to the apical end of the exposed tooth. This causes a higher cavitation in areas of the patient's teeth more prone to the occurrence of plaque and calculus build up. In other embodiments of the applicator 12, (e.g., FIG. 3A) the transducers 40A, 40B can be disposed within the applicator 12 so that the center of the outputs 41A, 41B are aligned with the center lines 31, 35 of the buccal wall 30 and lingual wall 32 respectively.

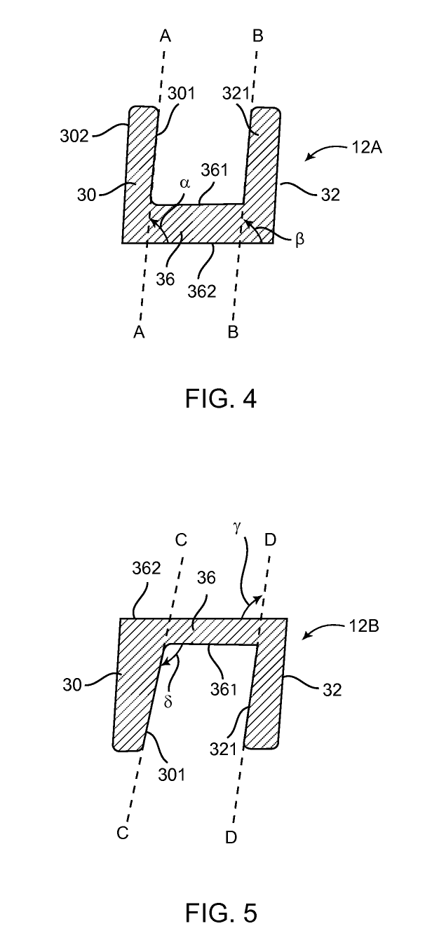

Referring to FIG. 4, one embodiment of an applicator 12A according to the present invention is designed for use with a maxillary arch (upper arch) of a patient. As shown in FIG. 4, an inner side 301 of the buccal wall 30 defines a line A-A which is disposed at an angle relative to an outer side 302 of the buccal wall which is substantially perpendicular to the occlusal wall 36. As shown in FIG. 4, the angular disposition of the inner side of the buccal wall (line A-A) is measured via the angle alpha defined between the substantially parallel upper and lower sides 361, 362 respectively, of the occlusal wall 36 of the applicator 12A and the line A-A. In one embodiment, the angle alpha is in a range of about 75 degrees to about 90 degrees. In another embodiment of applicator 12, the angle alpha is in a range of about 85 degrees to about 90 degrees.

Similarly, a line B-B is defined by an interior side 321 of the lingual wall 32. The angle beta is defined between the sides 361, 362 of the occlusal wall 36 and the line B-B. Similar to the angle alpha, in various embodiments of applicator 12, the angle beta is in a range of about 75 degrees to about 90 degrees. In another embodiment, the angle beta is in a range of about 85 degrees to about 90 degrees. Accordingly, in some embodiments, the applicator 12A is designed so that the buccal wall 30 and lingual wall 32 have interior sides which correspond generally to the angulation of the teeth of the maxillary arch of the patient. Thus, the cleaner apparatus 10 may include a plurality of various applicators 12 configured for use with patients having teeth of various angulations. Typically, the posterior teeth of the maxillary arch in most patients are angled slightly buccally in a coronal direction. Accordingly, in another embodiment, the applicator 12 includes at least one of the lingual wall and the buccal wall disposed at an angle relative to the occlusal wall and configured to accept teeth in the maxillary arch of the patient which are angled slightly buccally in a coronal direction.

In another embodiment, the angle, alpha of the inner side 301 of the buccal wall varies throughout the length of the maxillary arch so as to better correspond to the angulation of the maxillary arch of a patient's teeth. For example, in one embodiment the angle alpha at the anterior portion of the applicator 12B (in a range of about 88 degrees to about 92 degrees) and increase towards the posterior end of the applicator (in a range of about 75 degrees to about 88 degrees). Thus, in some embodiments, the shape of the applicator 12 allows for greater angulation of a patent's teeth towards the posterior ends of the applicator.

Similarly, the applicator 12A, may include a lingual wall 32 defining an angle beta that varies throughout the length of the maxillary arch so as to better correspond to the angulation of the maxillary arch of a patient's teeth. Typically, the applicator 12A may include the lingual surface of each of the buccal wall 30 and lingual wall 32 being generally parallel one to the other throughout a length thereof. Thus, even if the buccal wall 30 and lingual wall 32 are angled somewhat to conform to the angulation of a patient's teeth, most embodiments of the applicator 12 include the buccal wall 30 and lingual wall 32 having a lingual side thereof being generally parallel one to the other. Thus, the angles alpha and beta of FIG. 4 are generally equal one to the other throughout a length of the corresponding buccal wall 30 and lingual wall 32.

Referring to FIG. 5, another embodiment of the applicator 12B configured for use with the mandibular arch (lower arch) of a patient is shown in cross section. A line D-D is defined by an interior side 321 of the lingual wall 32 and is disposed at an angle gamma, relative to the exterior side 362 of the occlusal wall 36. In one embodiment, the angle gamma is in a range of about 90 degrees to about 120 degrees. In another embodiment, the angle gamma is in a range of about 90 degrees to about 100 degrees. In another embodiment, the angle gamma is in a range of about 90 to about 105 degrees.

Similarly, the lingual side 301 of the buccal wall 30 defines a line C-C and is disposed at an angle delta relative to both the interior 361 and exterior 362 sides of the occlusal wall 36. In one embodiment, the angle delta is in a range of about 90 degrees to about 120 degrees. In another embodiment, the angle delta is in a range of about 90 degrees to about 100 degrees.

In most embodiments of the applicator 12B, the angle gamma and delta are substantially equal throughout a length of the lingual wall 32 and buccal wall 30 respectively, however some embodiments may include the buccal wall 30 to define a greater angle delta relative to the occlusal wall 36 than the angle gamma of the lingual side of the lingual wall 32.

Typically, the posterior teeth of the mandibular arch in most patients are angled slightly lingually in a coronal direction. Accordingly, in another embodiment, the applicator 12 includes at least one of the lingual wall and the buccal wall disposed at an angle relative to the occlusal wall and configured to accept teeth in the mandibular arch of the patient which are angled slightly lingually in a coronal direction.

Although, not shown in FIGS. 4 and 5, the embodiments of the applicators 12A and 12B of FIGS. 4 and 5, include transducers 40A and 40B arranged parallel to the plane of the lingual sides of the walls, i.e. parallel to the lines A-A, B-B, C-C, D-D. Accordingly the outputs of the transducers, 41A, 41B are positioned generally perpendicular to the buccal surface and lingual surface of the patient's teeth, respectively. The angular disposition of the buccal wall 30 and lingual wall 32 is configured generally parallel to the axis of the teeth to maximize the effect of the cavitation created via the transducers 40A and 40B, thereby reducing the overall time required for a teeth cleaning process. Additionally, the angular position of the buccal wall 30 and lingual wall 32 can lead to reduced power requirements to drive the transducers 40A, 40B during a cleaning process.

Referring again to FIG. 1, the controller 14 includes a power cord 60 for connecting the controller to a power source. The controller 14 has a control panel 62 which includes a power switch 64 for turning the controller on and off. The controller 14 includes a display panel 66 for displaying an operational status of the cleaner apparatus 10. A timer control 68 is provided for setting the duration of the operation of the transducers 40A, 40B during a cleaning process. In one embodiment, the controller 14 is configurable to operate all of the transducers of the applicator 12 at the same time and the same power level. The timer control 68 is utilized to shut off the transducers after a predefined duration of time for the cleaning process (e.g., the timer can be set for a 5 minute period for operation one or more of the transducers 40A, 40B during a 5 minute cleaning process). In another embodiment, the controller 14 includes a selector 70 for selecting a portion of the transducers 40A, 40B to operate at a given time during a cleaning process. In one embodiment, the transducers 40A, 40B are numbered to facilitate proper selection of a portion thereof during a cleaning process. Alternatively, the selector 70 can be configured to identify one or more groups of the transducers 40A, 40B for selection of a group of the transducers. For example, in one embodiment, the controller 14 is configured to operate the transducers 40A, 40B in each quadrant of the dentition (half of the arch) at the same time. Alternatively, in another embodiment, the controller 14 is configurable to operate the transducers 40A disposed in the buccal wall 30 at one time, followed by the transducers 40B disposed in the lingual wall 32.

A selector 72 is configured to control a range of power for the selected transducers 40A, 40B. For example, the power can be selected incrementally in a range of low power=1 to high power=10. In one embodiment controller 14 includes a frequency control 74 for selecting a frequency applied to, or transmitted from the transducers 40A, 40B. Thus, the selectors 72 and 74 are configured to control the excitation of the transducers 40A, 40B and the output therefrom.

In another embodiment of apparatus 10, the controller 14 is configured to power transducers 40A, 40B in certain areas of the applicator 12 at different power levels than other of the transducers depending on the location of the transducers. For example, in one embodiment, the transducers 40B located at the anterior portion of the lingual wall 32 of the applicator 12 can be powered at a different (typically greater) power level than other areas of the applicator for increasing the cavitation created by the transducers in areas of known concentrations of plaque and calculus. Similarly, the selectors 70, 72 can be configured to operate the transducers in an area of the applicator 12 at reduced power where there is little plaque and/or calculus to be removed from a patient's teeth.

As shown in FIG. 3, each of the transducers 40A, 40B are coupled to the controller through an electrical wiring 80 embedded in the occlusal wall 36 of the applicator 12 and configured to pass through an anterior portion of the buccal wall 30 and the handle 18 and connect to the controller via the connector 20 and cable 16.

In one embodiment, the controller 14 is preset to operate the transducers at predetermined frequency and power so that only the timer control 68 needs to be set by the operator of the controller 14. Thus, the controller 14 is typically used in the preset configuration so that the operation thereof is standardized based on factory experimentation and preset power and frequency levels.

Not shown in the drawings, a cleaning agent such as a gel, foam, or high viscosity liquid is disposed in the cavity 22 of the applicator 12 for providing a cavitation medium for the cleaning process. Although any type of liquid, gel or foam cleaning agent can be used with the apparatus 10, a gel, foam or high viscosity cleaning agent is less susceptible to leak from the applicator 12 during placement of the applicator about a dental arch of the patient.

The applicator 12 defines a width W between the lingual side of each of the buccal wall 30 and the lingual wall 32 for receiving the teeth of the patient and also to allow space between the lingual surface of the teeth and the lingual wall 32 and the buccal surface of the teeth and the buccal wall 30 of the applicator for allowing for cavitation of the cleaning agent to engage the surfaces or the teeth. In one embodiment of the cleaner apparatus 10, a width of the cavity 22 formed in the applicator 12 is uniform throughout a length of the cavity. Alternatively, in another embodiment of the cleaner apparatus 10, a width of the arch-shaped cavity 22 formed in the applicator varies throughout the length of the cavity from a narrowest point near an anterior end of the cavity and wider points at each of a pair of opposing distal ends of the applicator.

The cavitation of the cleaning agent being sufficient to loosen the plaque and calculus from the teeth surfaces during a cleaning process. In one embodiment of the applicator 12, the width W is in a range of between about 8 mm to about 20 mm or more, depending on the size of the applicator 12. For example, in a small size applicator, the width W may be in a range of about 10 mm to about 12 mm. In other embodiments, the width W of the cavity 22 of applicator 12 may have a different range of widths.

In one embodiment, the cleaner apparatus 10 includes a set of applicators 12 configured with cavities 22 of various widths for use with different patients including children and adults. The set of applicators 12 includes applicators defining cavities having widths of:

| Size of Applicator 12 | Width (W) of cavity 22 in millimeters |
|---|---|
| X-small | 10 |
| Small | 12 |
| Medium | 15 |
| Large | 17 |
| X-Large | 20 |

Referring to FIG. 6, a top view of another applicator 12 according to the present invention showing the cavity 22 having a width that is varied between a widest point W1 near the distal wall 34 end of the applicator 12 for receiving a patient's molars and a narrowest point W2 at the anterior side of the applicator for receiving a patient's incisors. In one embodiment, the width W1 is in a range of about 10 mm to about 20 mm and the width W2 is in a range of about 8 mm to about 15 mm.

The varied width of the applicator 12 accounts for the difference in the diameters of a patient's teeth and provides for a uniform spacing between the patient's teeth and the transducers 40A, 40B throughout the length of the applicator 12. Thus, the source of the cavitation directed towards the teeth is spaced from the teeth with greater uniformly throughout the length of the applicator 12.

Since the cleaner apparatus 10 uses cavitation of the cleaning agent to clean a patient's teeth and gums, includes no moving parts, and is configured to clean an entire dental arch of a patient's teeth at one time, the cleaner apparatus 10 of the present invention provides for a fast, comfortable and efficient cleaning experience for the patient. The drawbacks identified hereinabove of the prior art teeth cleaning processes using scaling instruments are greatly overcome and mostly eliminated by the present invention cleaner apparatus 10 and method of use.

Example embodiments and methods thus being described, it will be appreciated by one skilled in the art that example embodiments and example methods may be varied through routine experimentation and without further inventive activity. Variations are not to be regarded as departure from the spirit and scope of the exemplary embodiments, and all such modifications as would be obvious to one skilled in the art are intended to be included within the scope of the following claims.

What is claimed is:

1. An ultrasonic cleaner apparatus for use in a dental prophylaxis process comprising:
an applicator defining a curved occlusal wall, a buccal wall, a lingual wall, and a distal wall, each of the buccal wall, the lingual wall and a distal walls extending outwardly from the occlusal wall and cooperating to form an arch-shaped cavity configured to receive a patient's teeth in one of the maxillary arch and mandibular arch of the patient, the applicator being further configured to receive and contain a cleaning agent in the cavity during a teeth cleaning process;
at least one ultrasonic transducer embedded within each of the buccal wall and the lingual wall of the applicator;
a controller electrically connectable to the transducers for powering the transducers and controlling the operation thereof; and
the cleaner apparatus for cleaning a full arch of a patients teeth via cavitation of the cleaning agent resulting from ultrasonic radiation transmitted from the transducers.

2. The cleaner apparatus of claim 1 further comprising:
a plurality of applicators including a first applicator configured for use with the maxillary arch of the patient, and a second applicator configured for use with the mandibular arch of the patient; and
the first and second applicators being different one from the other.

3. The cleaner apparatus of claim 1 wherein the controller is configured to operate the transducers in accordance with a predetermined time duration.

4. The cleaner apparatus of claim 1 wherein the applicator is configured for use with a maxillary arch of a patient, the buccal wall of the applicator being disposed at an angle relative to a plane of the occlusal wall, the angle alpha being in a range of about 75 degrees to about 90 degrees.

5. The cleaner apparatus of claim 1 wherein the applicator is configured for use with a maxillary arch of a patient, the lingual wall of the applicator being disposed at an angle beta relative to a plane of the occlusal wall, the angle alpha being in a range of about 75 degrees to about 90 degrees.

6. The cleaner apparatus of claim 1 wherein the applicator is configured for use with a mandibular arch of a patient, the lingual wall of the applicator being disposed at an angle gamma relative to a plane of the occlusal wall, the angle alpha being in a range of about 75 degrees to about 90 degrees.

7. The cleaner apparatus of claim 1 wherein the applicator is configured for use with a mandibular arch of a patient, the buccal wall of the applicator being disposed at an angle delta relative to a plane of the occlusal wall, the angle alpha being in a range of about 90 degrees to about 105 degrees.

8. The cleaner apparatus of claim 1 wherein a width of the cavity formed in the applicator is uniform throughout a length of the cavity.

9. The cleaner apparatus of claim 1 wherein a width of the arch-shaped cavity formed in the applicator varies throughout the length of the cavity from a narrowest point near an anterior end of the cavity and wider points at each of a pair of opposing distal ends of the applicator.

10. The cleaner apparatus of claim 1 wherein the transducer embedded in the lingual wall includes an output having a center positioned between a center line of the lingual wall and an opening of the cavity.

11. The cleaner apparatus of claim 1 wherein the transducer embedded in the buccal wall includes an output having a center positioned between a center line of the buccal wall and an opening of the cavity.

12. An ultrasonic cleaner apparatus for use in a dental prophylaxis process comprising:
first and second applicators, each of the first and second applicator defining a curved occlusal wall, a buccal wall, a lingual wall, and a distal wall, each of the buccal wall, the lingual wall and a distal walls extending outwardly from the occlusal wall and cooperating to form a cavity configured to receive a patient's teeth in one of the maxillary arch and mandibular arch of the patient, each of the first and second applicators being further configured to receive and contain a cleaning agent in the cavity during a teeth cleaning process;
the first applicator being configured for use with the maxillary arch of a patient, the second applicator being configured for use with the mandibular arch of the patient, the first applicator being different from the second applicator.
at least one ultrasonic transducer embedded within each of the buccal wall and the lingual wall of each of the first and second applicators;
a controller electrically connectable to the transducers for powering the transducers and controlling the operation thereof; and
the cleaner apparatus for cleaning a full arch of a patients teeth via cavitation of the cleaning agent resulting from ultrasonic radiation transmitted from the transducers.

13. The cleaner apparatus of claim 12 wherein the first applicator includes at least one of the lingual wall and the buccal wall disposed at an angle relative to the occlusal wall and configured to receive teeth in the maxillary arch of the patient which are angled slightly buccally in a coronal direction.

14. The cleaner apparatus of claim 12 wherein the second applicator includes at least one of the lingual wall and the buccal wall disposed at an angle relative to the occlusal wall and configured to receive teeth in the mandibular arch of the patient which are angled slightly lingually in a coronal direction.

15. The cleaner apparatus of claim 10 wherein the transducer embedded in the lingual wall of the second apparatus includes an output having a center positioned between a center line of the lingual wall and an opening of the cavity.

16. The cleaner apparatus of claim 10 wherein the transducer embedded in the lingual wall of the first apparatus includes an output having a center positioned between a center line of the lingual wall and an opening of the cavity.

17. A method of cleaning a patient's teeth using a full arch ultrasonic cleaning apparatus, the method comprising:
providing a cleaning apparatus comprising:
an applicator defining a curved occlusal wall, a buccal wall, a lingual wall, and a distal wall, each of the buccal wall, the lingual wall and a distal walls extending outwardly from the occlusal wall and forming a curved applicator configured to receive a patient's teeth in one of the maxillary arch and mandibular arch of the patient, the applicator being further configured to receive and contain a cleaning agent in the cavity during a teeth cleaning process;
at least one ultrasonic transducer embedded within each of the buccal wall and the lingual wall of the applicator,
a controller electrically coupled to the transducers for powering the transducers and controlling the operation thereof;
loading a cleaning agent in the cavity;
applying the applicator to one of the maxillary arch and the mandibular arch of the patient;
operating the controller to apply electrical power to at least one of the ultrasonic transducers thereby causing cavitation in the cleaning agent; and
wherein the cavitation in the cleaning agent works to remove plaque and calculus from the patient's teeth.

18. The method of claim 16 wherein the applicator defines a cavity having at least one of the buccal and lingual walls being disposed at an angle relative to the occlusal wall, the cavity being configured to receive teeth in the maxillary arch of the patient which are angled slightly buccally in a coronal direction.

19. The method of claim 16 wherein the applicator defines a cavity having at least one of the buccal and lingual walls being disposed at an angle relative to the occlusal wall, the cavity being configured to receive teeth in the mandibular arch of the patient which are angled slightly lingually in a coronal direction.
